(19) United States
(12) Patent Application Publication
(10) Pub. No.: US 2010/0314988 A1
(43) Pub. Date: Dec. 16, 2010

(54) RESINATES CONTAINING ACQUEOUS DEVELOPABLE PHOTOIMAGEABLE CARBON NANOTUBE PASTES WITH ENHANCED PERFORMANCE

(75) Inventors: Haixin Yang, Chapel Hill, NC (US); Angel R. Cartagena, Apex, NC (US); Terry Roland Suess, Raleigh, NC (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/809,865

(22) PCT Filed: Dec. 19, 2008
(86) PCT No.: PCT/US08/87697

§ 371 Date: Aug. 11, 2010

Related U.S. Application Data
(60) Provisional application No. 61/008,686, filed on Dec. 21, 2007.

(51) Int. Cl. H01J 1/02; H01B 1/04; H01B 1/12; H01B 5/00

(52) U.S. Cl. 313/311; 252/506; 252/503; 174/126.1; 977/742; 977/750; 977/752; 977/939

(57) ABSTRACT

Disclosed are novel photoimageable compositions for improving the emission of electron field emitters. These compositions are comprised of carbon nanotubes and metal resinate.

### FIELD OF THE INVENTION

The invention concerns a novel photoimageable paste composition for improving the uniformity of electron field emitters. This composition is comprised of acicular carbon (e.g. carbon nano-tubes) and metal resinate. The composition is useful in FED television and backlighting applications.

### TECHNICAL BACKGROUND OF INVENTION

Field emission electron sources, often referred to as field emission materials or field emitters, can be used in a variety of electronic applications, e.g., vacuum electronic devices, flat panel computer and television displays, emission gate amplifiers, and back-lighting.

Display screens are used in a wide variety of applications such as home and commercial televisions, laptop and desktop computers and indoor and outdoor advertising and information presentations. Flat panel displays can be an inch or less in thickness in contrast to the deep cathode ray tube monitors found on most televisions and desktop computers. Flat panel displays are a necessity for laptop computers, but also provide advantages in weight and size for many of the other applications. Currently laptop computer flat panel displays use liquid crystals, which can be switched from a transparent state to an opaque one by the application of small electrical signals. It is difficult to reliably produce these displays in sizes larger than that suitable for laptop computers.

Plasma displays have been proposed as an alternative to liquid crystal displays. A plasma display uses tiny pixel cells of electrically charged gases to produce an image and requires relatively large electrical power to operate.

Flat panel displays having a cathode using a field emission electron source, i.e., a field emission material or field emitter, and a phosphor capable of emitting light upon bombardment by electrons emitted by the field emitter have been proposed. Such displays have the potential for providing the visual display advantages of the conventional cathode ray tube and the depth, weight and power consumption advantages of the other flat panel displays. U.S. Pat. Nos. 4,857,799 and 5,015,912 disclose matrix-addressed flat panel displays using micro-tip cathodes constructed of tungsten, molybdenum or silicon. WO 94-15352, WO 94-15350 and WO 94-28571 disclose flat panel displays wherein the cathodes have relatively flat emission surfaces.

Field emission has been observed in two kinds of nanotube carbon structures. L. A. Chemozatonskii et al., Chem. Phys. Letters 233, 63 (1995) and Mat. Res. Soc. Symp. Proc. Vol. 359, 99 (1995) have produced films of nanotube carbon structures on various substrates by the electron evaporation of graphite in 10.sup.−5 10.sup.−6 torr (1.3.times.10.sup.−3 1.3.times.10.sup.−4 Pa). These films consist of aligned tube-like carbon molecules standing next to one another. Two types of tube-like molecules are formed; the A-tubelites whose structure includes single-layer graphite-like tubules forming filaments-bundles 10 30 nm in diameter and the B-tubelites, including mostly multilayer graphite-like tubes 10 30 nm in diameter with conoid or dome-like caps. They report considerable field electron emission from the surface of these structures and attribute it to the high concentration of the field at the nanodimensional tips. B. H. Fishbine et al., Mat. Res. Soc. Symp. Proc. Vol. 359, 93 (1995) discuss experiments and theory directed towards the development of a buckytube (i.e., a carbon nanotube) cold field emitter array cathode. A. G. Rinzler et al., Science 269, 1550 (1995) report the field emission from carbon nanotubes is enhanced when the nanotubes tips are opened by laser evaporation or oxidative etching. W. B. Choi et al., Appl. Phys. Lett. 75, 3129 (1999) and D. S. Chung et al., J. Vac. Sci. Technol. B 18(2) report the fabrication of a 4.5 inch flat panel field display using single-wall carbon nanotubes-organic binders. The single-wall carbon nanotubes were vertically aligned by paste squeezing through a metal mesh, by surface rubbing and/or by conditioning by electric field. They also prepared multi-wall carbon nanotube displays. They note that carbon nanotube field emitters having good uniformity were developed using a slurry squeezing and surface rubbing technique. They found that removing metal powder from the uppermost surface of the emitter and aligning the carbon nanotubes by surface treatment enhanced the emission. Single-wall carbon nanotubes were found to have better emission properties than multi-wall carbon nanotubes but single-wall carbon nanotube films showed less emission stability than multi-wall carbon nanotube films. Zettl et al., U.S. Pat. No. 6,057,637 claim a field emitter material comprising a volume of binder and a volume of B.sub.xC.sub.yN.sub.z nanotubes suspended in the binder, where x, y and z indicate the relative ratios of boron, carbon and nitrogen.

N. M. Rodriguez et al., J. Catal. 144, 93 (1993) and N. M. Rodriguez, J. Mater. Res. 8, 3233 (1993) discuss the growth and properties of carbon fibers produced by the catalytic decomposition of certain hydrocarbons on small metal particles. U.S. Pat. No. 5,149,584, U.S. Pat. No. 5,413,866, U.S. Pat. No. 5,458,784, U.S. Pat. No. 5,618,875 and U.S. Pat. No. 5,653,951 disclose uses for such fibers.

There is a continuing need for improved technology enabling the use of acicular carbon (e.g. carbon nanotubes) in electron field emitters. U.S. Pat. No. 7,276,844 disclosed a new process for improving the emission of electron filed emitters. The process use photoimageable CNT pastes to make fine size (about 20 microns in diameter) emitters and to improve emission. One issue associated with field emitters, such as that at 20 microns in diameter, has been that some emitters are damaged or lost after the processing, i.e. from photo-imaging, development, firing and activation. Then, the not-so-uniform emitters result in not uniform emission. There is a need to make emitters uniform after processing.

The present invention improves emitter uniformity by the addition of metal resinates into photoimageable CNT pastes. Other modifications, such as the photoinitiator system are also changed, to accommodate the addition of the metal resinates.

### SUMMARY OF THE INVENTION

The present invention is directed to an improved carbon nano-tube (CNT) and metal resinate screen printable and photoimageable paste offering uniform emitters after processing.

The invention comprises: a composition for use as a screen printable paste containing solids comprising carbon nanotubes, wherein the carbon nanotubes are less than 9 wt % of the total weight of solids in the paste. More preferred is the composition wherein the carbon nanotubes are less than 5 wt % of the total weight of solids in the paste. Still more preferred is the composition wherein the carbon nanotubes are less than 1 wt % of the total weight of solids in the paste. Most preferred is the composition wherein the carbon nanotubes are about 0.01 wt % to about 2 wt % of the total weight of solids in the paste. The paste also comprises metal resinates, from 0.1% to 6.5%, preferably 1.5-4%. This paste is especially useful in fabricating an electron field emitter which then undergoes the improvement process of the invention. Such an emitter has excellent emitter uniformity and emission properties along with the advantages of ease of preparing and comparatively low cost of materials and processing.

The improved electron field emitters disclosed herein are useful in flat panel computer, television and other types of displays, vacuum electronic devices, emission gate amplifiers, klystrons and in lighting devices. The process is especially advantageous for producing large area electron field emitters for flat panel displays, i.e., for displays greater than 30 inches (76 cm) in size. The flat panel displays can be planar or curved.

### BRIEF DESCRIPTION OF THE DRAWINGS

FIG. 1 and FIG. 2 are photographs comparing coated articles with the standard paste (FIG. 1) and the improved paste described herein (FIG. 2).

### DETAILED DESCRIPTION OF THE INVENTION

The current firing temperature for CNT-emitter pastes is under about 450 degrees C. At such a lower temperature, almost all inorganic materials, such glass frits, alumina powder fillers and other inorganic binder materials would not be able to soften or melt enough to bind CNTs to the substrate surface. Resinates are organo-metallic materials which decompose at a low temperature, typically lower than 300 C, to form either pure metal or metal alloys or metal oxides. When resinates are mixed into CNT emitter pastes, they decompose during the process of firing CNT emitters and form in-situ metals or alloys or metal oxides. The resulting metals, alloys or oxides serve as binders of CNT emitters to substrate surfaces. By designing the resinate and resinate mixtures in CNT pastes, as taught herein, a variety of binder metals or metal alloys or metal oxides binders can be obtained to enhance adhesion of CNT emitters to a variety of substrate surfaces.

In order to retain good photoiaging capability of photoimageable CNT pastes to form fine emitters, the photoinitiator system was also developed.

The acicular carbon used herein can be of various types. Carbon nanotubes are the preferred acicular carbon and thin wall carbon nanotubes are especially preferred. The individual thin wall carbon nanotubes are typically 2-4 walls. The carbon nanotubes are sometimes described as graphite-like, presumably because of the sp.sup.2 hybridized carbon. The wall of a carbon nanotube can be envisioned as a cylinder formed by rolling up a graphene sheet.

Various processes can be used to attach acicular carbon to a substrate. The means of attachment must withstand and maintain its integrity under the conditions of manufacturing the apparatus into which the field emitter cathode is placed and under the conditions surrounding its use, e.g. typically vacuum conditions and temperatures up to about 450.degree. C. As a result, organic materials are not generally applicable for attaching the particles to the substrate and the poor adhesion of many inorganic materials to carbon further limits the choice of materials that can be used. A preferred method is to screen print a paste comprised of acicular carbon and glass frit, metallic powder or metallic paint or a mixture thereof onto a substrate in the desired pattern and to then fire the dried patterned paste. For a wider variety of applications, e.g., those requiring finer resolution, the preferred process comprises screen printing a paste which further comprises a photoinitiator and a photohardenable monomer, photopatterning the dried paste and firing the patterned paste.

The substrate can be any material to which the paste composition will adhere. If the paste is non-conducting and a non-conducting substrate is used, a film of an electrical conductor to serve as the cathode electrode and provide means to apply a voltage to and supply electrons to the acicular carbon will be needed. Silicon, a glass, a metal or a refractory material such as alumina can serve as the substrate. For display applications, the preferable substrate is glass and soda lime glass is especially preferred. For optimum conductivity on glass, silver paste can be pre-fired onto the glass at 500-550.degree. C. in air or nitrogen, but preferably in air. The conducting layer so-formed can then be over-printed with the emitter paste.

The photopatterning emitter paste used for screen printing typically contains acicular carbon, a metal resinate, a photoimageable organic medium which comprises a photoinitiator system, an aqueous developable binder polymer and photohardenable monomers, solvent, surfactant, and either low softening point glass frit, metallic powder or metallic paint or a mixture thereof.

The emitter paste is typically prepared by three-roll milling a mixture of acicular carbon, organic medium, surfactant, a solvent and either low softening point glass frit, metallic powder or metallic paint or a mixture thereof.

The paste mixture can be screen printed using well-known screen printing techniques, e.g. by using a 325-400 mesh stainless steel screen on to a substrate. The screen printed paste is then photopatterned via a photomask to form a latent image. The patterned paste is then developed by Na2CO3 aqueous solution to for desired emitters or paste patterns. The emitters are then fired at a temperature of about 350.degrees C. to about 550.degrees C., preferably under 450.degrees. C peak temperature for 10 minutes in either air or nitrogen. Higher firing temperatures can be used with substrates which can endure them provided the atmosphere is free of oxygen.

Commonly assigned U.S. Pat. No. 7,276,844 describes several examples demonstrating the use of photoimagable carbon-nanotube pastes. The use of the present paste is similar and consists of the following procedure.

### I. Carbon Nanotubes

Carbon nanotubes are q key functional material. They are carefully selected to give desired emission performance. They can be single wall or multi-walls, preferably, 2 to 4 walls.

### II. Metallic Resinates

As used herein are organo-metallic materials which typically decompose at a low temperature, typically lower than 300 C, to form either pure metal or metal alloys or metal oxides. When resinates are mixed into CNT emitter pastes, they decompose during the process of firing CNT emitters and form in-situ metals or alloys or metal oxides. The resulting metals, alloys or oxides serve as binders of CNT emitters to substrate surfaces. By designing the resinate and resinate mixtures in CNT pastes, as taught herein, a variety of binder metals or metal alloys or metal oxides binders can be obtained to enhance adhesion of CNT emitters to a variety of substrate surfaces.

### III. Organic Medium

The main purpose of the organic medium is to serve as a vehicle for dispersion of the finely divided solids of the composition in such form that it can readily be applied to a glass or other substrate. Thus, the organic medium must first be one in which the solids are dispersible with an adequate degree of stability. Secondly, the rheological properties of the organic medium must be such that they lend good application properties to the dispersion. Third, they must be photoimageable and aqueous developable to allow form patterns. A typical medium composition is shown in Table 2. The main components of the medium follow:

### A. Polymer

The polymer binder is important to the compositions of this invention. They have aqueous developability and give a high resolving power.

They are made of copolymer, interpolymer or mixtures thereof, wherein each copolymer or interpolymer comprises (1) a nonacidic comonomer comprising a C1-10 alkyl acrylate, C1-10 alkyl methacrylate, styrenes, substituted styrenes or combinations thereof and (2) an acidic comonomer comprising ethylenically unsaturated carboxylic acid containing moiety. Examples of the vinyl group include, but are not limited to methacrylate and acrylate groups. The copolymer, interpolymer or mixture thereof has an acid content of at least 10 wt. % of the total polymer weight; a glass transition temperature of 50-150° C. and an weight average molecular weight in the range of 2,000-250,000 and all ranges contained within.

The presence of acidic comonomer components in the composition is important in this technique. The acidic functional group provides the ability to be developed in aqueous bases such as aqueous solutions of 0.4-2.0% sodium carbonate. When acidic comonomers are present in concentrations of less than 10%, the composition is not washed off completely with an aqueous base. When the acidic comonomers are present at concentrations greater than 30%, the composition is less resistant under development conditions and partial development occurs in the image portions. Appropriate acidic comonomers include ethylenically unsaturated monocarboxylic acids such as acrylic acid, methacrylic acid, or crotonic acid and ethylenically unsaturated dicarboxylic acids such as fumaric acid, itaconic acid, citraconic acid, vinyl succinic acid, and maleic acid, as well as their hemiesters, and in some cases their anhydrides and their mixtures. Because they are cleaner burning in low-oxygen atmospheres, methacrylic polymers are preferred over acrylic polymers.

When the nonacidic comonomers are alkyl acrylates or alkyl methacrylates as mentioned above, it is preferable that these nonacidic comonomers constitute at least 50 wt. %, preferably 70-75 wt. %, of the polymer binder. When the nonacidic comonomers are styrene or substituted sytrenes, it is preferable that these nonacidic comonomers constitute 50 wt. % of the polymer binder and that the other 50 wt. % is an acid anhydride such as the hemiester of maleic anhydride. A favorable substituted styrene is alpha-methylstyrene.

Although not preferable, the nonacidic portion of the polymer binder can contain up to about 50 wt. % of other nonacidic comonomers as substitutes for the alkyl acrylate, alkyl methacrylate, styrene, or substituted styrene portions of the polymer. Examples include acrylonitrile, vinyl acetate, and acrylamide. The use of single copolymers or combinations of copolymers as binders are recognized as long as each of these satisfies the various standards above. In addition to the above copolymers, adding small amounts of other polymer binders is possible. For examples of these, polyolefins such as polyethylene, polypropylene, polybutylene, polyisobutylene, and ethylene-propylene copolymers, polyvinyl alcohol polymers (PVA), polyvinyl pyrrolidone polymers (PVP), vinyl alcohol and vinyl pyrrolidone copolymers, as well as polyethers that are low alkylene oxide polymers such as polyethylene oxide can be cited.

Furthermore, the weight average molecular weight of the polymer binder is in the range of 2,000-250,000 and any ranges contained therein, preferably 5000-10,000.

The total polymer in the composition is in the range of 5-70 wt. %, preferably 20-40%, based on total composition and any ranges contained therein.

### B. Photohardenable Monomer

Conventional photohardenable methacrylate monomers may be used in the invention. Depending on the application, it is not always necessary to include a monomer in the composition of the invention. Monomer components are present in amounts of 1-20 wt. %, based on the total weight of the dry photopolymerizable layer. Such preferred monomers include t-butyl acrylate and methacrylate, 1,5-pentanediol diacrylate and dimethacrylate, N,N-diethylaminoethyl acrylate and methacrylate, ethylene glycol diacrylate and dimethacrylate, 1,4-butanediol diacrylate and dimethacrylate, diethylene glycol diacrylate and dimethacrylate, hexamethylene glycol diacrylate and dimethacrylate, 1,3-propanediol diacrylate and dimethacrylate, decamethylene glycol diacrylate and dimethyacrylate, 1,4-cyclohexanediol diacrylate and dimethacrylate, 2,2-dimethylolpropane diacrylate and dimethacrylate, glycerol diacrylate and dimethacrylate, tripropylene glycol diacrylate and dimethacrylate, glycerol triacrylate and trimethacrylate, trimethylolpropane triacrylate and trimethacrylate, pentaerythritol triacrylate and trimethacrylate, polyoxyethylated trimethylolpropane triacrylate and trimethacrylate and similar compounds as disclosed in U.S. Pat. Nos. 3,380,831, 2,2-di(p-hydroxy-phenyl)-propane diacrylate, pentaerythritol tetraacrylate and tetramethacrylate, 2,2-di-(p-hydroxyphenyl)-propane dimethacrylate, triethylene glycol diacrylate, polyoxyethyl-2,2-di-(p-hydroxyphenyl)propane dimethacrylate, di-(3-methacryloxy-2-hydroxypropyl)ether of bisphenol-A, di-(2-methacryl-oxyethyl)ether of bisphenol-A, di-(3-acryloxy-2-hydroxypropyl)ether of bisphenol-A, di-(2-acryloxyethyl)ether of bisphenol-A, di-(3-methacrloxy-2-hydroxypropyl)ether of 1,4-butanediol, triethylene glycol dimethacrylate, polyoxypropyltrimethylol propane triacrylate, butylene glycol diacrylate and dimethacrylate, 1,2,4-butanetriol triacrylate and trimethacrylate, 2,2,4-trimethyl-1,3-pentanediol diacrylate and dimethacrylate, 1-phenyl ethylene-1,2-dimethacrylate, diallyl fumarate, styrene, 1,4-benzenediol dimethacrylate, 1,4-diisopropenyl benzene, and 1,3,5-triisopropenyl benzene. Also useful are ethylenically unsaturated compounds having a weight average molecular weight of at least 300, e.g., alkylene or a polyalkylene glycol diacrylate prepared from an alkylene glycol of 2 to 15 carbons or a polyalkylene ether glycol of 1 to 10 ether linkages, and those disclosed in U.S. Pat. No. 2,927,022, e.g., those having a plurality of free radical polymerizable ethylenic linkages particularly when present as terminal linkages. Particularly preferred monomers are polyoxyethylated trimethylolpropane triacrylate, ethylated pentaerythritol triacrylate, dipentaerythritol monohydroxypentaacrylate and 1,10-decanediol dimethlacrylate.

### C. Photoinitiation System

Suitable photoinitiation systems are those, which generate free radicals upon exposure to actinic light at ambient temperature. These include the substituted or unsubstituted polynuclear quinones which are compounds having two intracyclic carbon atoms in a conjugated carbocyclic ring system, e.g., 2-benzyl-2-(dimethylamino)-1-(4-morpholinophenyl)-1-butanone, 2,2-dimethoxy-2-phenylacetophenone, 9,10-anthraquinone, 2-methylanthraquinone, 2-ethylanthraquinone, 2-tert-butylanthraquinone, octamethylanthraquinone, 1,4-naphthoquinone, 9,10-phenanthrenequinone, benz (a) anthracene-7,12-dione, 2,3-naphthacene-5,12-dione, 2-methyl-1,4-naphthoquinone, 1,4-dimethyl-anthraquinone, 2,3-dimethylanthraquinone, 2-phenylanthraquinone, 2,3-diphenylanthraquinone, retenequinone, 7,8,9,10-tetrahydronaphthracene-5,12-dione, and 1,2,3,4-tetra-hydrobenz(a)anthracene-7,12-dione. Other photoinitiators which are also useful, even though some may be thermally active at temperatures as low as 85 C, are described in U.S. Pat. No. 2,760,863 and include vicinal ketaldonyl alcohols such as benzoin, pivaloin, acyloin ethers, e.g., benzoin methyl and ethyl ethers; -hydrocarbon-substituted aromatic acyloins, including -methylbenzoin, -allylbenzoin and -phenylbenzoin, thioxanthone and/or thioxanthone derivatives and the appropriate hydrogen donors. Photoreducible dyes and reducing agents disclosed in U.S. Pat. Nos. 2,850,445, 2,875,047, 3,097,096, 3,074,974, 3,097,097, and 3,145,104, as well as dyes of the phenazine, oxazine, and quinone classes, Michler's ketone, benzophenone, 2,4,5-triphenylimidazolyl dimers with hydrogen donors including leuco dyes and mixtures thereof as described in U.S. Pat. Nos. 3,427,161, 3,479,185, and 3,549,367 can be used as initiators. Also useful with photoinitiators and photoinhibitors are sensitizers disclosed in U.S. Pat. No. 4,162,162. The photoinitiator or photoinitiator system is present in 0.05 to 10% by weight based on the total weight of a dry photopolymerizable layer.

### D. Solvents

The solvent component of the organic medium, which may be a mixture of solvents, is chosen so as to obtain complete solution therein of the polymer and other organic components. The solvent should be inert (non-reactive) towards the other constituents of the composition. For screen printable and photoimageable pastes, the solvent(s) should have sufficiently high volatility to enable the solvent to be evaporated from the dispersion by the application of relatively low levels of heat at atmospheric pressure, however, the solvent should not be so volatile that the paste rapidly dries on a screen, at normal room temperatures, during the printing process. The preferred solvents for use in the paste compositions should have boiling points at atmospheric pressure of less than 300° C. and preferably less than 250° C. Such solvents include aliphatic alcohols, esters of such alcohols, for example, acetates and propionates; terpenes such as pine oil and alpha- or beta-terpineol, or mixtures thereof; ethylene glycol and esters thereof, such as ethylene glycol monobutyl ether and butyl cellosolve acetate; carbitol esters, such as butyl carbitol, butyl carbitol acetate and carbitol acetate and other appropriate solvents such as Texanol® (2,2,4-trimethyl-1,3-pentanediol monoisobutyrate). For casting tapes, the solvent(s) have lower boiling points than solvents used for screen printable pastes. Such solvents include ethylacetate, methanol, isoproanol, acetone, xylene, ethanol, methylethyl ketone and toluene.

### E. Other Additives

Frequently the organic medium will also contain one or more plasticizers. Such plasticizers help to assure good lamination to substrates and enhance the developability of unexposed areas of the composition. The choice of plasticizers is determined primarily by the polymer that must be modified. Among the plasticizers which have been used in various binder systems are diethyl phthalate, dibutyl phthalate, butyl benzyl phthalate, dibenzyl phthalate, alkyl phosphates, polyalkylene glycols, glycerol, poly(ethylene oxides), hydroxy ethylated alkyl phenol, tricresyl phosphate triethyleneglycol diacetate and polyester plasticizers. Additional components known in the art may be present in the composition including dispersants, stabilizers, release agents, dispersing agents, stripping agents, antifoaming agents and wetting agents. A general disclosure of suitable materials is presented in U.S. Pat. No. 5,049,480.

The composition of the present invention may be processed by using a firing profile known to those skilled in the art of thick film technology. Removal of the organic medium and sintering of the inorganic materials is dependent on the firing profile.

### Sample Preparation and Processing

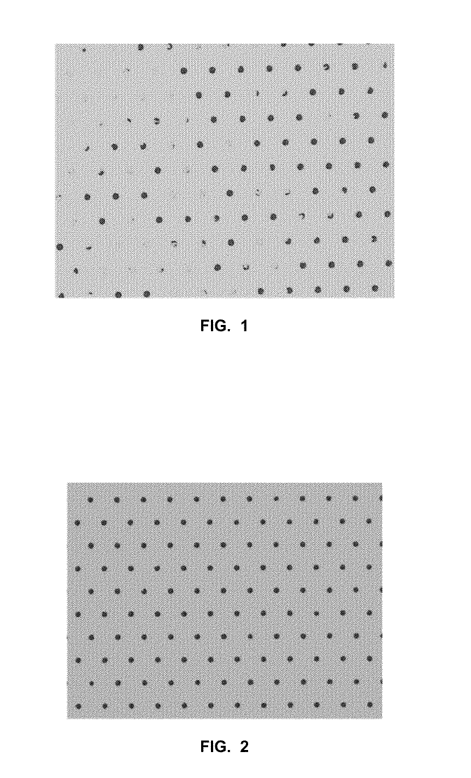

The photoimagable emitter paste is prepared by three roll-milling the carbon nanotube powder and organic medium together. A pre-formed organic photoresist layer with regular holes of 50 diameters on a glass substrate was prepared by coating AZ P4620 photoresist onto glass, followed by drying at 100 C for 10 minutes, and then developed by AZ 300 MIF developer solution. The photoimagable emitter paste was then screen printed under yellow light onto the pre-fired organic photoresist layer to file the regular holes using a 325-400 mesh screen and the sample was subsequently dried at 120.degree. C. for 5-10 minutes. The dried sample was then photo-patterned by using a photo tool containing an UV light transparent pattern of “DUPONT”. An UV dose of 50-200 mJ/cm2 was used for exposure. The exposed sample was developed in 0.5% carbonate aqueous solution to wash out the unexposed area of the sample. The developed sample was then rinsed thoroughly in water and allowed to dry. The sample was then fired in air or nitrogen for 10 minutes at 400.degree. C. After firing, CNT emitters form on the substrate. A piece of Scotch™ Magic™ Tape, (#810-3M Company) was then applied to and contacted with the electron field emitters and then removed. A portion of the electron field emitter adhered to the Scotch™ Magic™ Tape. The electron field emitters remaining on glass substrate were inspected for emitter uniformity and photographed, such as FIG. 1 and FIG. 2. The emitters were then tested for field emission, using a diode structure known by anyone skilled in the field. The emitters showed a good uniformity and high density emission across the entire patterned surface of the electron field emitter.

### EXAMPLES

### Glossary of Materials for Examples

Organic medium: A solution made of 53.15% of acrylate polymer, 30% of solvent, 15.5% of photoinitiators and 0.06% of inhibitor.
Solvent: alpha-Terpineol, purchased from DRT, France.
Polymer: A copolymer of 80%, by weight, methyl methacrylate and 20% methacrylic acid, weight average molecular weight Mw=˜7,000, acid number=˜125, purchased from Noveon.
Photoinitiator I: Irgacure 907, purchased from Ciba Specialty Chemicals.
Photoinitiator II: DETX, 2,4-diethyl-9H-thioxanthen-9-one DETX speedcure from Aceto Corporation.
Inhibitor: TAOBN, 1,4,4-trimethyl-2,3-diazabicyclo[3,2,2]-non-2-ene-N, N′-dioxide by DuPont.
Carbon Nanotubes (CNT): Thin Wall Carbon Nanotubes, purchased from Cheap Tubes, Inc.
Alumina: Alumina AKP-20 (D50=0.5 microns), purchased from Sumitomo Chemicals.
Monomer I: SB510E35, acrylate monomer/oligomer blend, purchased from Sartomer.
Monomer II: SR-454, Trimethylolpropane ethoxy triacrylate, purchased from Sartomer.
Malnonic acid: purchased from Aldrich Chemicals.
Surfactant: Poly(alphamethyl siloxanes), purchased from BYK-Chemie.
Silver resinate: Silver neodecanonate, purchased from OMG America.
Tin resinate: Dibutyltin dilaurate, purchased from OMG America.
Indium resinate: Indium Hex-Cem, purchased from OMG America.

TABLE I
Example Compositions

| | Example I | Example II | Example III | Example IV | Example V | Example VI | Example VII | Example VIII | Example IX |
|---|---|---|---|---|---|---|---|---|---|
| Organic Medium | 76.1 | 76.1 | 76.1 | 76.1 | 76.1 | 76.1 | 76.1 | 76.1 | 76.1 |
| Alumina | 5.9 | 5.9 | 5.9 | 5.9 | 5.9 | 5.9 | 5.9 | 5.9 | 5.9 |
| Monomer I | 6.7 | 6.7 | 6.7 | 6.7 | 6.7 | 6.7 | 6.7 | 6.7 | 6.7 |
| Monomer II | 6.7 | 6.7 | 6.7 | 6.7 | 6.7 | 6.7 | 6.7 | 6.7 | 6.7 |
| CNT | 0.5 | 0.5 | 0.5 | 1.5 | 3 | 0.5 | 3 | 1.5 | 1.5 |
| Silver resinate | 1 | 3 | 6.5 | 6.5 | 6.5 | | | | 1 |
| Indium Resinate | | | | | | 0.5 | 1.5 | 3 | 1 |
| Tin Resinate | | | | | | 0.5 | 1.5 | 3.5 | 1 |
| Surfactant | | 0.6 | 0.6 | 0.6 | 0.6 | | 0.6 | 0.6 | 0.6 |

TABLE II
A Typical Organic Medium Formulation

| | Organic |
|---|---|
| | Medium |
| Solvent | 53 |
| Polymer | 30.00 |
| Photoinitiator | |
| I | 4 |
| Photoinitiator | |
| II | 12 |
| Inhibitor | 0.1 |
| Manonic acid | 0.9 |

Examples I-V demonstrated compositions with silver resinate. Example VI-VIII demonstrated compositions with indium resinate and tin resinate, and Example IX demonstrated a composition with both silver resinate and indium and tin resinates.

What is claimed is:

1. A field emitter paste composition comprising:
carbon nanotubes, metal resinate, and one or more members of the group consisting of particles;
a photoinitiator;
a developable binder; and
a photohardenable monomer.

2. The filed emitter paste of claim 1 wherein the metal resinate is selected from the group consisting of silver, indium or tin.

3. A field emitter cathode comprising:
(a) a substrate; and
(b) a field emitter cathode paste composition comprising a composition of carbon nanotubes, metal resinate and one or more members of the group consisting of particles, a photoinitiator, a developable binder and a photohardenable monomer.

4. The cathode of claim 1 or 3 wherein, the carbon nanotubes are single wall carbon nanotubes.

5. The cathode of claim 3 wherein, the cathode composition resides on a surface of the substrate as a layer.

6. The field emitter paste composition of claim 1 wherein, nanotubes are present in the cathode composition in an amount of less than 9 weight percent.

7. A field emission display device comprising:
(a) an anode; and
(b) a cathode wherein the cathode comprises:
(i) a substrate,
(ii) an electrically conducting film deposited on the substrate, and
(iii) a field emission cathode paste composition that is overprinted on the electrically conducting film, wherein the cathode paste composition comprises carbon nanotubes metal resinate and one or more members of the group consisting of a photoinitiator, a developable binder and a photohardenable monomer.

8. The display device of claim 6 wherein the carbon nanotubes are single wall carbon nanotubes.

9. The display device of claim 6 wherein, the cathode composition resides on a surface of the substrate as a layer.

10. The cathode of claim 3 wherein, the carbon nanotubes are aligned.

11. The cathode of claim 3 wherein, the carbon nanotubes are multi-wall carbon nanotubes.

12. The cathode of claim 3 wherein, nanotubes are present in the cathode composition in an amount of less than about 5 weight percent.

13. The cathode of claim 3 wherein, nanotubes are present in the cathode composition in an amount of from about 0.01 weight percent to about 2 weight percent.

14. The cathode of claim 1 which is fabricated into in a flat panel computer, a television, a display, a vacuum electronic device, an emission gate amplifier, a klystron or a lighting device.

15. The cathode of claim 1 wherein the particles are metal particles.

16. The cathode of claim 1 wherein the particles are aluminum particles.

17. The field emitter paste of claim 2 wherein the metal resinate is a silver resinate.

18. The field emitter paste of claim 2 wherein the metal resinate is an indium resinate.

19. The field emitter paste of claim 2 wherein the metal resinate is a tin resinate.
